(19) United States
(12) Patent Application Publication
(10) Pub. No.: US 2010/0169132 A1
(43) Pub. Date: Jul. 1, 2010

(54) EXECUTING A BUSINESS TRANSACTION IN AN ENTERPRISE SYSTEM USING BUSINESS DATA OBTAINED FROM HETEROGENEOUS SOURCES

(76) Inventors: Tobias Hoppe-Boeken, Wiesbaden (DE); Peter Lorenz, Dossenheim (DE); Armin Schwarz, Gaiberg (DE); Amrish Singh, Pittsburgh, PA (US)

Correspondence Address: SAP AG, 3410 HILLVIEW AVENUE, PALO ALTO, CA, 94304, US

(21) Appl. No.: 12/344,592

(22) Filed: Dec. 29, 2008

(51) Int. Cl. G06Q 10/00; G06F 17/30; G06F 3/048; G06F 7/06

(52) U.S. Cl. 705/7; 715/738; 707/E17.032; 707/E17.014; 707/E17.016; 707/E17.044

(57) ABSTRACT

Disclosed is a method and system for receiving business data regarding an entity from various disparate sources, structuring the received data in an enterprise system and executing a business transaction using the structured data. The method involves receiving business data of an entity from a plurality of sources, determining a part of the business data that is relevant to a business process based on a business context from the plurality of sources and mapping the part of the business data to fields of a business object in an enterprise system. Further, a business object instance of the business object is created and a business transaction is executed using the business object instance.

### FIELD OF THE INVENTION

The invention generally relates to the field of enterprise software applications. More particularly the invention relates to collecting unstructured business data from various sources, converting it to a structured data and executing a business transaction using the structured data.

### BACKGROUND OF THE INVENTION

People use the web browser and a variety of external web sources to gather information in an unstructured process. They match the information from these sources manually to make decisions and then use an enterprise system to process a business transaction which is typically a time consuming process. Consider an example of a purchaser in a company looking to find new sources of supply. This is usually a time consuming activity requiring the strategic purchaser to browse a variety of information catalogues, such as Yellow Pages to find the companies related to specific categories, Company Websites to determine company specific profile information, Supplier Index Directories for ranking, Finance Websites for financial news and analysis, as well as news and other media sources to obtain various information about the suppliers. After collecting all the information obtained from the above sources, the purchaser has to compare that with the supplier data already existing in the company's enterprise software to make a decision. The information from these different sources is typically heterogeneous in nature, takes a lot of time to collect, manage and compare. Finally the user needs to make a decision and then use enterprise software for creating a “Request for Quotation” and sending it to the selected supplier. Current enterprise applications do not provide a way of gathering business data from various sources and presenting them to the user in a single user interface.

### SUMMARY OF THE INVENTION

Described are methods and systems for receiving business data of an entity from various sources, structuring the received data in an enterprise system and executing a business transaction using the structured data. The method involves receiving business data of an entity from a plurality of sources, determining a part of the business data that is relevant to a business process based on a business context and mapping the part of the business data to fields of a business object in an enterprise system. Further, a business object instance of the business object is created and a business transaction is executed using the business object instance.

A mash component engine extracts the business data from the source in a format based on a type of the source. A mapping tool extracts the relevant information from the business data and maps the relevant part to fields of a business object in the enterprise system. Finally, the execution engine creates an instance of the business object and executes a business transaction using the business object.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is an exemplary screen display of an information space user interface to display business data of an entity obtained from various sources according to an embodiment of the invention.

FIG. 2 is an exemplary screen display of a result of the business transaction executed in the information space user interface of FIG. 1 according to an embodiment of the invention.

FIG. 3 is a flow diagram for executing a business transaction in an enterprise system using the business data obtained from various sources according to an embodiment of the invention.

FIG. 4 is a block diagram of a system for executing a business transaction in an enterprise system using the business data obtained from various sources according to an embodiment of the invention.

FIG. 4A is an exemplary really simple syndicate (RSS) document containing business data of an entity received from an RSS feed according to an embodiment of the invention.

FIG. 5 is a block diagram of a system for displaying the business data obtained from various sources according to an embodiment of the invention.

### DETAILED DESCRIPTION

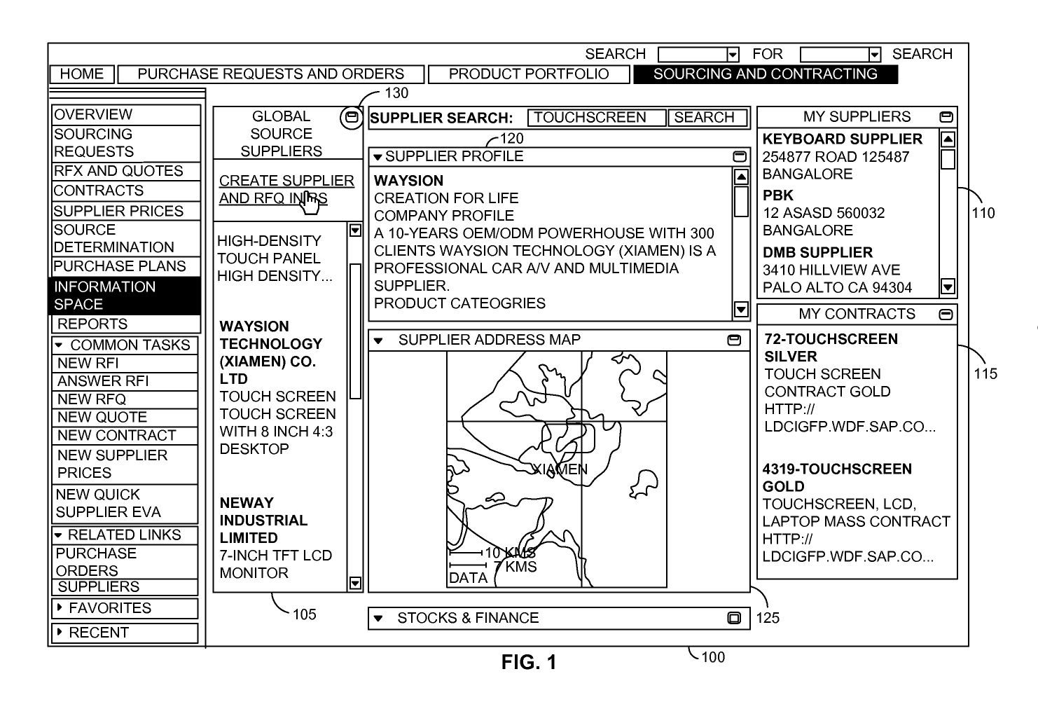

FIG. 1 is an exemplary screen display of an information space 100 user interface to display business data of an entity obtained from various heterogeneous sources and to execute a business transaction using the business data according to an embodiment of the invention. For example, in a supply chain management scenario, information space 100 displays various business data of a product “touch screen”. The business data displayed includes a list of suppliers for “touch screen”, details of the suppliers such as a profile of the supplier, a location of the supplier, and various contracts with suppliers. Further, a user may execute a business transaction in the information space 100 using a supplier data from the list of suppliers.

The information space 100 obtains the supplier list from sources such as internet and various internal systems within the organization. The supplier list is obtained in various formats. The supplier lists obtained from various sources have to be structured into a format that is understandable by an enterprise application in an enterprise system to execute business transactions. After the necessary information such as a supplier name, a supplier identification (ID), a supplier address are extracted from the supplier lists, they are mapped to fields of a business object in the enterprise application. Later, a business transaction is executed by using the business object. The business transaction includes but is not limited to creating a new supplier in the enterprise system, creating a request for quote for the new supplier, creating a purchase order, and creating a sales order.

The information space 100 displays various lists of suppliers that are obtained from internal and external sources of an organization. The global source suppliers list 105 is obtained from an external source such as internet, for example, “www.globalsources.com”. The global source suppliers list 105 is obtained as a really simple syndicate (RSS) feed. RSS is a family of Web feed formats used to publish frequently updated works—such as blog entries, news headlines, any listings, audio, and video—in a standardized format. An RSS feed includes full or summarized text, plus metadata such as publishing dates and authorship.

Also, only the necessary information of a supplier is extracted from the RSS feed and displayed in global source suppliers list 105. The necessary information is the information relevant to a business context of the business transaction. In other words, it is the information that is required to execute a business transaction for a supplier. For example, the business transaction such as a “request for quotation” may require a user to know the supplier details including but not limited to a supplier name, a supplier ID, a supplier company profile, supplier contact details, and product details.

The my suppliers list 110 is obtained from an internal source such as an enterprise system within the organization that has the data of suppliers who have supplied various products to the organization. In an embodiment, the my suppliers list 110 may contain only the suppliers of the product “touch screen” which the user is looking for. A profile of the supplier may be viewed in supplier profile 120 and a location map of the supplier may be viewed in supplier address map 125. The information space 100 also displays my contracts list 115 that provides contract details of the suppliers in my suppliers list 110.

The information space 100 enables a user to get a comprehensive view of the business data about a particular entity in a single user interface. For example, a user in the organization wanting to buy the product “touch screen” can make use of the information space 100 to obtain a list of suppliers for touch screen. The information space 100 provides a list of suppliers from both internal and external sources. The user may view the profile of a potential supplier such as how long has the supplier been in business, a rating of the supplier, supplier's capability to supply in large scale, time taken by the supplier, where the supplier is located and other terms and conditions of the supplier, compare the potential supplier with a supplier in the my suppliers list 110 and then make a decision whether to purchase the product from the potential supplier. The user may do all the above within a single user interface such as information space 100. In this way, the user is not required to enter the details of a supplier manually, log into different systems for finding different information and executing different business transactions.

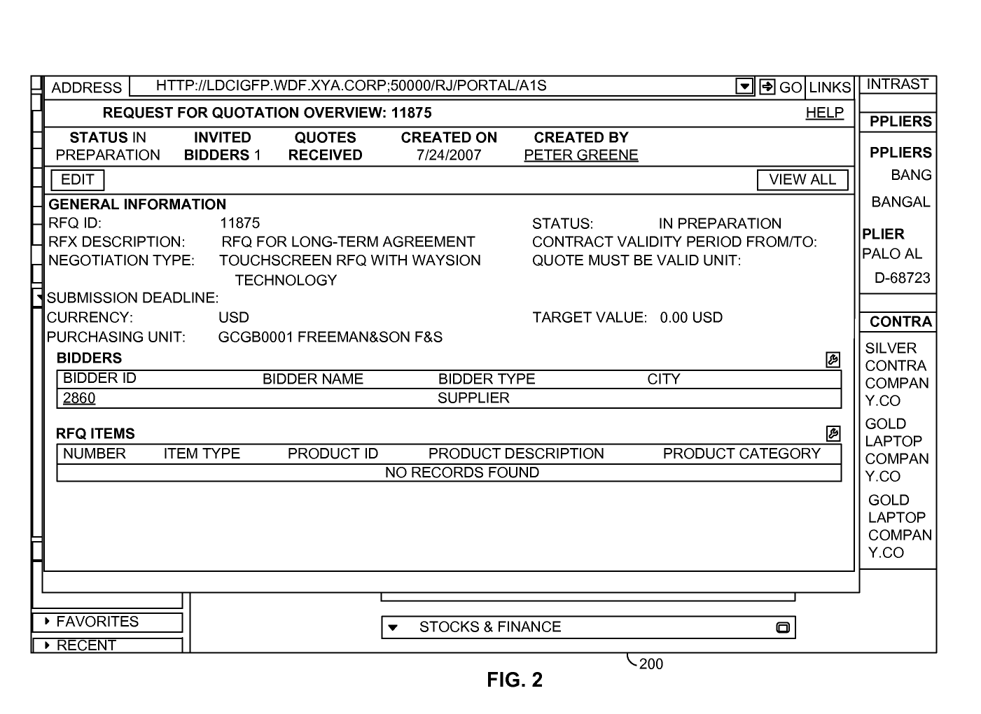

After choosing a potential supplier from the global source suppliers list 105, the user can execute a business transaction on the chosen supplier using the button 130. The button 130 provides a list of business transactions that includes but not limited to creation of a supplier business object, creating a request for quotation, creating a purchase order in the enterprise system etc. The user may choose a business transaction, for example, “create a request for quotation” and create a request for quote as displayed in user interface 200 of FIG. 2.

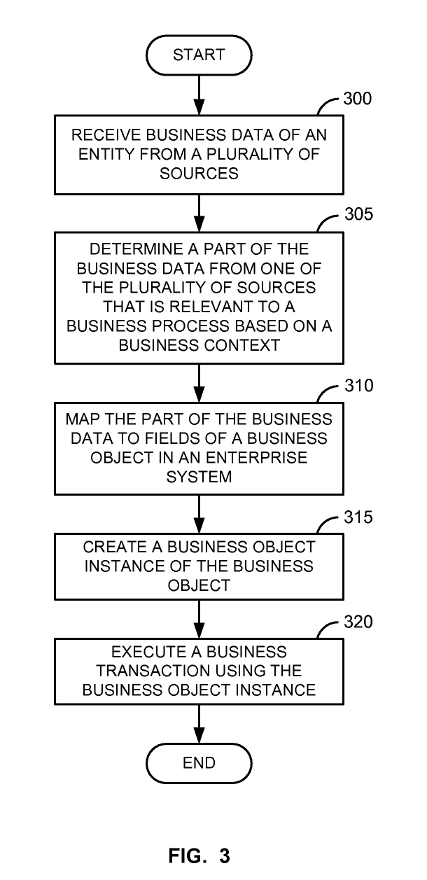

FIG. 3 is a flow diagram for executing a business transaction in an enterprise system using the business data obtained from various sources according to an embodiment of the invention. At step 300, business data of an entity is received from a plurality of sources. For example, business data such as a list of suppliers of a product may be received from internal sources and external sources of an organization as shown in information space 100. The business data may be received in different formats such as RSS, hyper text markup language (HTML), simple object access protocol (SOAP) used for exchanging structured information via extensible markup language (XML) format, and business intelligence consumer services (BICS) protocol used for retrieving data from business intelligence system. Furthermore, the business data obtained from various external sources may contain various levels of details.

At step 305, a part of the business data that is relevant to a business transaction is determined, that is, only the part of the business data that is necessary to execute a business transaction is determined and extracted. For example, to execute a “create a request for quotation” business transaction, details such as a supplier name, a supplier ID, a supplier company profile, supplier contact details, and product details are required. These fields are identified and extracted from the business data.

At step 310, the extracted part of the business data is mapped to fields of a business object in an enterprise system such as SAP R/3® system provided by SAP® AG. For example, a supplier name of a supplier from global source suppliers list 105 is mapped to “BusinessObject. Name” field, a supplier number of the supplier from global source suppliers list 105 is mapped to “BusinessObject. ID” field, and a supplier address of the supplier from global source suppliers list 105 is mapped to “BusinessObject. Address” field in the enterprise system.

After the part of the business data is mapped to the fields of the business object in the enterprise system, at step 315, a business object instance of the business object is created. At step 320, a business transaction is executed using the business object instance. The business object contains a defined set of business transactions that can be executed. The set of business transactions includes but is not limited to creation of a supplier business object, creating a request for quotation, and creating a purchase order in the enterprise system.

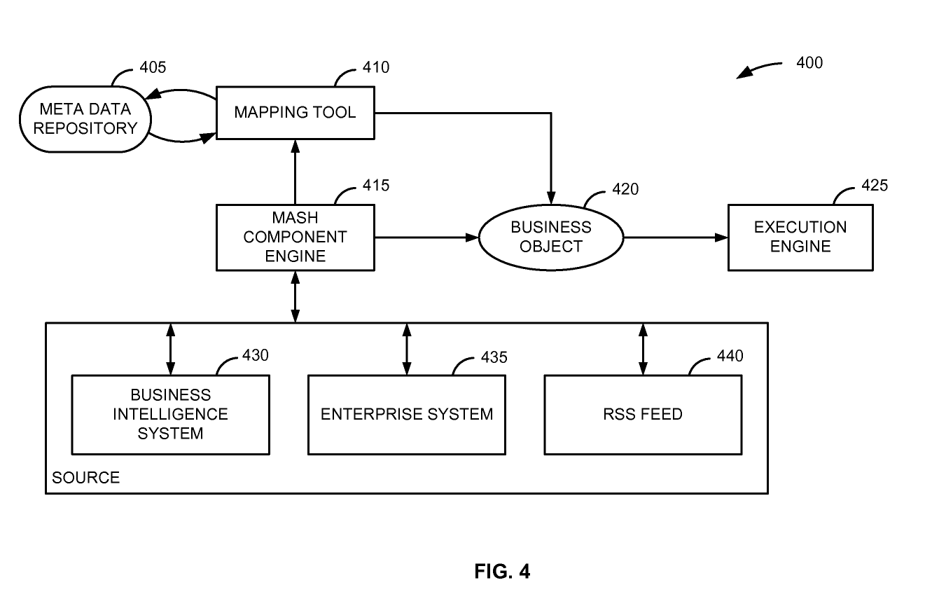

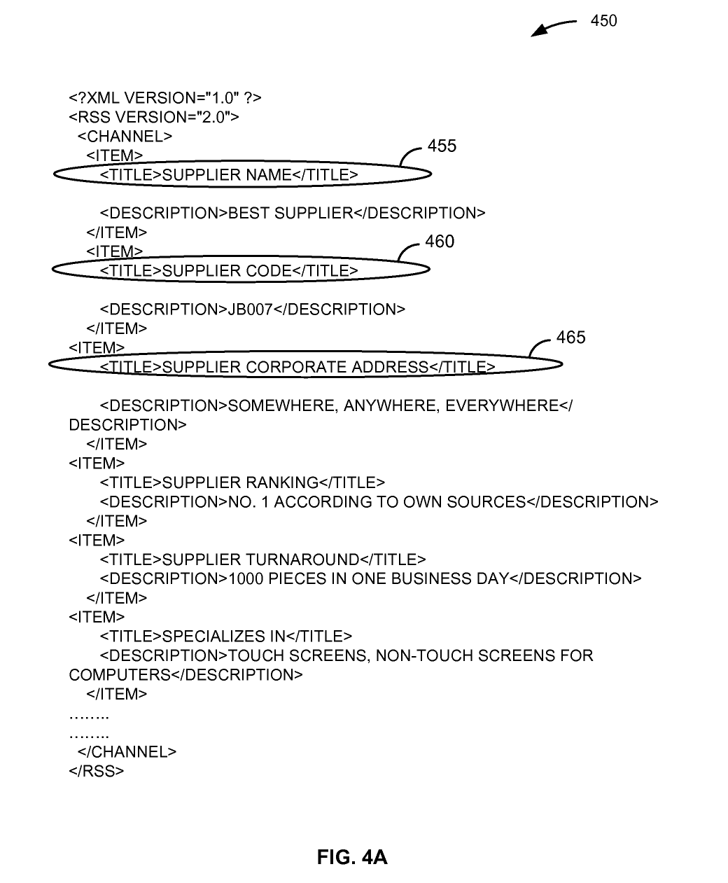

FIG. 4 is a block diagram of a system 400 for executing a business transaction in an enterprise system using the business data obtained from various sources according to an embodiment of the invention. System 400 receives business data of an entity such as a list of suppliers of a product from a plurality of sources. The plurality of sources includes internal sources such as business intelligence system 430 and enterprise system 435, and an external source such as RSS feed 440. In an embodiment, business intelligence system 430 includes a SAP Business Intelligence (BI) system provided by SAP® AG, and enterprise system 435 includes SAP R/3® system provided by SAP® AG. The RSS feed 440 includes an RSS feed from an internet source. The system 400 may include various other external sources such as any third party application, HTML source etc.

A mash component engine 415 extracts the business data from the plurality of sources based on a format in which the business data is provided by a source system. In an embodiment, the business intelligence system 430 provides the business data via BICS protocol, the enterprise system 435 via SOAP protocol and RSS feed 440 via RSS protocol. So, the mash component engine 415 identifies the source, extracts the business data from the source accordingly and converts it to a format such as Java objects that is understood by mapping tool 410.

The mapping tool 410 enables a user to convert an unstructured data obtained by external sources into a structured format by mapping the business data obtained from external source to a business object in the enterprise system 435. The mapping tool 410 obtains a definition of the business object 420 such as a supplier business object from a metadata repository 405 in an enterprise application. The user may map the business data obtained from an external source such as the RSS feed 440 to fields of the business object 420 obtained from the enterprise system 435.

FIG. 4A shows an exemplary RSS document 450 received from RSS feed 440 according to an embodiment of the invention. Apart from the business data shown in the RSS document 450, the RSS document 450 may have many other details that may not be relevant to a business process. So, only the fields that are relevant to the business transaction are mapped to the business object 420. For example, for creating a new supplier, information such as supplier name, supplier ID and supplier address are required among others. Therefore, these fields are identified and extracted from the RSS document 450 and mapped to the business object 420. In an embodiment, “Supplier Name” 455 is mapped to “BusinessObject. Name” field, “Supplier Code” 460 is mapped to “BusinessObject. ID” field, and “Supplier Corporate Address” 465 is mapped to “BusinessObject. Address” field in the business object 420.

After mapping the part of the business data to the business object 420, an execution engine 425 creates a business object instance of the business object 420 and executes a business transaction. The business transaction includes but is not limited to creating a new supplier in the enterprise system, creating a request for quote for the new supplier, creating a purchase order, and creating a sales order. The execution engine 425 obtains the business logic to execute the business transaction from the enterprise system 435.

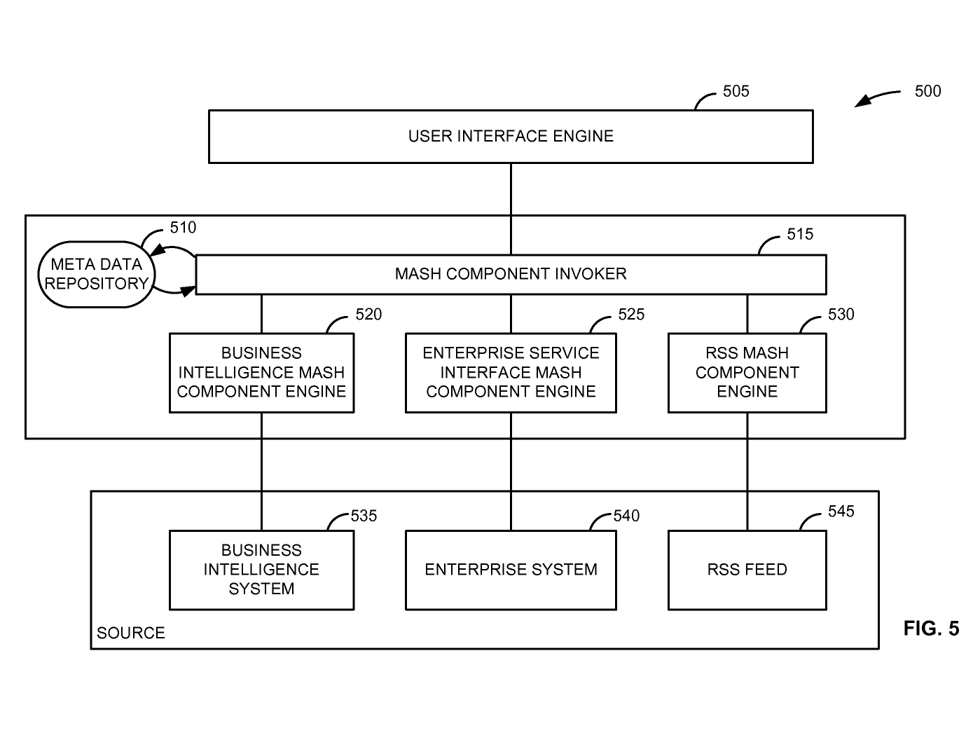

FIG. 5 is a block diagram of a system 500 for displaying the business data obtained from various sources according to an embodiment of the invention. The business data obtained from sources such as business intelligence system 535, enterprise system 540 and RSS feed 545 are displayed in a information space 100 user interface rendered by user interface engine 505. In the information space 100, when the user searches for suppliers of a product “touch screen”, the list of suppliers of “touch screen” are displayed in the information space 100. The list of suppliers includes global source suppliers list 105 obtained from external source and my suppliers list 110 obtained from internal sources such as business intelligence system 535 and enterprise system 540. The information space 100 also displays my contracts list 115 which are existing contracts with the suppliers in my suppliers list 110.

A mash component invoker 515 in communication with mash component engines makes it possible to gather business data of an entity from external and internal sources and display it in a single user interface such as information space 100. The mash component engines such as business intelligence (BI) mash component engine 520, enterprise service interface (ESI) mash component engine 525 and RSS mash component engine 530 enable exchanging the business data between the mash component invoker 515 and various sources. The mash component engines convert the business data from various formats including BICS, HTML, SOAP, and RSS to Java objects and vice versa when the business data is exchanged between the source and the mash component invoker 515. This design of having the mash component engines between the source and the mash component invoker 515 allows addition of any other type of an external source at a later stage with minimum changes to the enterprise application. The new external source may be used in the enterprise application just by adding a mash component engine that understands the format of the business data provided by the new external source.

The mash component invoker 515 co-ordinates obtaining data from various sources based on a business context of the application. Metadata repository 510 stores semantic information like the structure of a business object, for example, fields inside a supplier business object and the semantic mapping between mash component engines. The semantic mapping between the mash component engines defines a business context of the application. For example, the semantic mapping defines that enterprise service interface mash component engine 525 and RSS mash component engine 530 is required to execute a business transaction such as creating of a new supplier. The mash component invoker 515 uses the semantic mapping and transfers it into a function call to retrieve or create business objects, get result sets from a business intelligence, map an RSS result structure from any external RSS feed into a business object.

For example, the mash component invoker 515 creates a supplier business object in the enterprise system 540 by using the semantic mapping from the metadata repository 510 to obtain the supplier data from RSS feed 545 via RSS mash component engine 530, a structure of supplier business object from the metadata repository 510 and finally creates the supplier business object in the enterprise system 540 via ESI mash component engine 525.

Similarly to get the list of contracts, the mash component invoker 515 obtains a supplier ID from the user interface and uses the semantic mapping in the metadata repository to obtain a list of contracts for the supplier from the BI mash component engine 520. The mash component invoker 515 passes the supplier ID to BI mash component engine 520 and the BI mash component engine 520 obtains a list of contracts for the supplier from the business intelligence system 535. The mash component invoker 515 provides the list of contracts to the user interface engine 505 which displays my contracts list 115 in information space 100.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or any other type of machine-readable media suitable for tangibly storing electronic instructions. The machine readable medium can provide the instructions stored therein to a computer system comprising a processor capable of reading and executing the instructions to implement the method steps described herein.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. A computer implemented method for receiving heterogeneous data from disparate sources, structuring the received data in an enterprise system and executing a business transaction using the structured data, the method comprising:
receiving business data of an entity from a plurality of sources;
determining a part of the business data from one of the plurality of sources that is relevant to a business transaction based on a business context;
retrieving a mapping of the part of the business data with fields of a business object in an enterprise system;
creating a business object instance of the business object; and
executing the business transaction using the business object instance.

2. The computer implemented method in claim 1 further comprising:
obtaining the part of the business data from each of the plurality of sources based on the business context; and
presenting the part of the business data from each of the plurality of sources in an information space user interface.

3. The computer implemented method in claim 2, wherein the business context is defined by a semantic mapping between each of the plurality of sources in a metadata repository.

4. The computer implemented method in claim 1, wherein receiving business data from a plurality of sources comprises identifying a format of the business data based on each of the plurality of sources.

5. The computer implemented method of claim 1, wherein the business data comprise data selected from a group consisting of supplier details, logistics service provider details, product details, and customer details.

6. The computer implemented method of claim 1, wherein the plurality of sources comprises a source selected from a group consisting of internet, an enterprise system, and a web service.

7. The computer implemented method of claim 1, wherein receiving business data from a plurality of sources comprises receiving the business data via a protocol selected from a group consisting of a really simple syndication (RSS), a simple object access protocol (SOAP), a hyper text markup language (HTML), and a business intelligence consumer services (BICS).

8. The computer implemented method of claim 1, wherein a format of the business data includes a BICS format, a SOAP format, a RSS format, and a HTML format.

9. An article of manufacture, comprising:
a machine readable medium having instructions which when executed by a machine cause the machine to perform a method for receiving heterogeneous data from disparate sources, structuring the received data in an enterprise system and executing a business transaction using the structured data, the method comprising:
receiving business data of an entity from a plurality of sources;
determining a part of the business data that is relevant to a business process from each of the plurality of sources based on a business context;
retrieving a mapping of the part of the business data with fields of a business object in an enterprise system;
creating a business object instance of the business object; and
executing a business transaction using the business object instance.

10. The article of manufacture in claim 9 further comprising:
obtaining the part of the business data from each of the plurality of sources based on the business context; and
presenting the part of the business data from each of the plurality of sources in an information space user interface.

11. The article of manufacture in claim 10, wherein the business context is defined by a semantic mapping between each of the plurality of sources in a metadata repository.

12. The article of manufacture in claim 9, wherein receiving business data from a plurality of sources comprises identifying a format of the business data based on each of the plurality of sources.

13. The article of manufacture in claim 9, wherein receiving business data from a plurality of sources comprises receiving the business data via a protocol selected from a group consisting of really simple syndication (RSS), simple object access protocol (SOAP), hyper text markup language (HTML), and business intelligence consumer services (BICS).

14. The article of manufacture in claim 9, wherein a format of the business data includes a BICS format, a SOAP format, a RSS format, and a HTML format.

15. The article of manufacture in claim 9, wherein the business data comprise data selected from a group consisting of supplier details, logistics service provider details, product details, and customer details.

16. The article of manufacture in claim 9, wherein the plurality of sources comprises a source selected from a group consisting of internet, an enterprise system, and a web service.

17. A computer system including a processor and a memory, the memory comprising instructions that are executable by the processor, the system comprising:
a plurality of sources to provide business data of an entity;
a mash component engine to extract the business data from each of the plurality of sources;
a mash component invoker in communication with the mash component engine to determine a part of the business data that is relevant to a business transaction based on a business context;
a mapping tool to map the part of the business data to fields of a business object in an enterprise system; and
an execution engine to create a business object instance and execute a business transaction using the business object instance.

18. The system in claim 17 further comprising a metadata repository in communication with the mash component invoker to define a structure of the business object and a semantic mapping between each of the plurality of sources.

19. The system in claim 17 further comprising a user interface engine that renders an information space user interface to display the part of the business data from each of the plurality of sources based on the business context.
